(19) United States
(12) Patent Application Publication
(10) Pub. No.: US 2009/0313242 A1
(43) Pub. Date: Dec. 17, 2009

(54) CONTENT ASSESING APPARATUS, CONTENT SEARCHING APPARATUS, CONTENT ASSESING METHOD, CONTENT SEARCHING METHOD, AND FIRST AND SECOND COMPUTER PROGRAMS

(76) Inventor: Yasuteru Kodama, Tsurugashima-shi (JP)

Correspondence Address: YOUNG & THOMPSON, 209 Madison Street, Suite 500, Alexandria, VA, 22314, US

(21) Appl. No.: 12/305,884

(22) PCT Filed: Jul. 4, 2007
(86) PCT No.: PCT/JP2007/063362

§ 371 Date: Dec. 19, 2008

(30) Foreign Application Priority Data
Jul. 6, 2006 (JP) 2006-186321

(51) Int. Cl. G06F 17/30

(52) U.S. Cl. 707/5; 707/E17.014

(57) ABSTRACT

A content evaluation device includes: extraction means (11) for extracting a feature amount quantitatively characterizing a content for each of contents; interpolation means (22) for interpolating distribution of feature amounts associated with contents having a history affirmatively or negatively evaluated for one search word among the contents; and creation means (24) for creating a score curve for correlating a score to a feature amount. The content evaluation device further includes calculation means (25) for calculating a score according to the score curve thus created. This enables evaluation of matching degree.

### TECHNICAL FIELD

The present invention relates to a content assessing apparatus and method for assessing suitability for one search word related to one content of a plurality of contents, which are stored on a recoding apparatus, such as a music server, a first computer program which makes a computer function as the content assessing apparatus, a content searching apparatus and method for searching for a content using the content assessing apparatus, and a second computer program which makes a computer function as the content searching apparatus.

### BACKGROUND ART

As this type of content assessing apparatus and the content searching apparatus for searching for a content using the content assessing apparatus, a music selecting apparatus has been suggested, which aims at presenting music that is suitable for a user's feeling (refer to a patent document 1). According to this technology, a music piece with music feature amounts (e.g. degree of a change in chord, beat) corresponding to human characteristics (e.g. age, sex) and feeling words (e.g. “cheerful”, “sad”) set in advance is selected, in accordance with the feature amounts of a plurality of music pieces. At this time, a music piece with a certain feature amount is assessed on the basis of the magnitude of a feeling suitability value, which indicates how suitable the music piece is for the feeling word, and the music is selected on the basis of the assessment result.
Patent document 1: Japanese Patent Application Laid Open NO. 2005-209276

### DISCLOSURE OF INVENTION

### Subject to be Solved by the Invention

However, for example, according to the technology disclosed in the patent document 1 described above, the following problem can arise, so that a preferable search result is unlikely obtained. Specifically, the feeling suitability value is calculated on the basis of a distance from an average value in each feature amount, with regard to the selected feeling word (e.g. “cheerful”). This calculation method holds on the assumption that the distribution of the feature amount, which is a sample of the average value, is a normal distribution. Therefore, the reliability of the assessment can be reduced if the aforementioned assumption does not hold, such as a case where there are two or more peaks, a case where there is no apparent peak, or a case where there is one peak that is not bilaterally symmetric.

It is therefore an object of the present invention to provide a content assessing apparatus and method which can preferably assess a content such as a music piece, and a computer program which makes a computer function as the content assessing apparatus. Moreover, it is also an object of the present invention to provide a content searching apparatus and method which can preferably search for a content using the content assessing apparatus, and a computer program which makes a computer function as the content searching apparatus.

### Means for Solving the Subject

(Content Assessing Apparatus)

The above object of the present invention can be achieved by a content assessing apparatus for assessing suitability for one search word related to one content of a plurality of contents, which are stored on a recoding apparatus, the content assessing apparatus provided with: an extracting device for extracting a feature amount, which quantitatively features the content, for each of the plurality of contents; an interpolating device for interpolating a distribution of the feature amount related to the content having a history of being assessed positively or negatively in the one search word, of the plurality of contents; a making device for making a score curve in which a score is associated with the feature amount, on the basis of the interpolated distribution; and a calculating device for calculating the score, on the basis of the made score curve.

According to the content assessing apparatus of the present invention, for example, the score for assessing the suitability for the one search word related to the one content of the plurality of contents, which are stored on the recoding apparatus, such as a music server, is calculated as follows. The “content” here is the content and its data, which are stored on the recording apparatus and which can be an assessment target by a user, such as a music piece, a video image, or a homepage. The “search word” indicates in which viewpoint the content is assessed; namely, it is a word which indicates an axis of assessment. Typically, the search word indicates a user's subjective feeling, such as “cheerful”, “quiet”, or “groovy”. The search word is selected from a plurality of candidates, by the user in advance in the assessment, or automatically. Then, if the search word of “cheerful” is selected, how “cheerful” the one content is for the user is assessed as the score. The “score for assessing the suitability” is an index for quantitatively assessing how suitable the one content is for the one search word, at least in two steps. Typically, the two steps are “FIT (i.e. positive assessment of being “suitable”)” and “UNFIT (i.e. negative assessment of being “not suitable”)”.

In calculating the aforementioned score, firstly, the feature amount which quantitatively features the content (e.g. a rhythm speed, an average value of audio level, a speed of change in chord, center of gravity in a frequency spectrum, and the like if the contents are music pieces) is extracted for each of the plurality of contents by the extracting device having an arithmetic apparatus or the like.

The distribution of the feature amount related to the content having the history of being assessed positively or negatively, of the plurality of contents, is interpolated by the interpolating device having an arithmetic apparatus or the like. The “history of being assessed positively or negatively” herein is a history of being assessed positively (i.e. “FIT”) or negatively (i.e. “UNFIT”), in the one search word in the past. From the distribution pattern of the feature amount of the content having the history of being assessed positively or negatively as described above, the score of the one content, which is the assessment target, is estimated in effect. The “interpolation” indicates changing the discrete distribution of the feature amount to a continuous distribution, using an interpolation technique, such as a mixture Gaussian model.

On the basis of the distribution interpolated as described above, the score curve in which the score is associated with the feature amount is made by the making apparatus having an arithmetic apparatus or the like. The “score curve” herein is simply the interpolated distribution itself, but it may be a score curve obtained by making some correction on the distribution as described later.

On the score curve made in this manner, the aforementioned score is calculated by the calculating device having an arithmetic apparatus or the like. Specifically, for example, the score is calculated by extracting the feature amount in the one search word related to the one content, which is a search target, and by reading the score corresponding to the extracted feature amount on the score curve. Incidentally, if there are a plurality of types of feature amounts, the scores in each of the feature amounts may be individually obtained and then totalized, to thereby calculate the final score. At this time, weighting for each score about each feature amount may be changed individually, and the totalized score may be regarded as the final score.

As a result, it is possible to preferably assess the suitability for the one search word related to the one content. Even if the distribution is not a normal distribution, the score curve is made on the basis of the interpolated distribution. Thus, the score accuracy is higher than the case where the score is calculated as the distance from the average value without the interpolation, which is extremely useful in practice.

In one aspect of the content assessing apparatus of the present invention, the interpolating device interpolates a first distribution of the feature amount related to the content having the history assessed positively of the plurality of contents and interpolates a second distribution of the feature amount related to the content having the history assessed negatively of the plurality of contents, and the making device makes the score curve by subtracting the interpolated second distribution from the interpolated first distribution.

According to this aspect, the first distribution of the feature amount related to the content having the history assessed positively, of the plurality of contents, and the second distribution of the feature amount related to the content having the history assessed negatively, of the plurality of contents, are interpolated by the interpolating device. Then, at least one score curve is made by the making device subtracting the interpolated second distribution from the interpolated first distribution. Then, on the basis of the score curve, the score is calculated in the aforementioned manner. As described above, since the score curve is made on the basis of not only the “history of being assessed positively” but also the “history of being assessed negatively”, the score curve is reflected by the user's feeing, more strongly, and the assessment accuracy is improved.

In another aspect of the content assessing apparatus of the present invention, the interpolating device further interpolates a third distribution of the feature related to the plurality of contents, and the content assessing apparatus is further provided with a correcting device for correcting the score curve on the basis of the interpolated third distribution so as to reduce a contribution by the third distribution to a shape of the score curve.

According to this aspect, the third distribution of the feature amount related to the plurality of contents is further interpolated by the interpolating device. The “plurality of contents” here are typically all the contents. Then, the score curve is corrected by the correcting device on the basis of the interpolated third distribution so as to reduce the contribution by the third distribution to the shape of the score curve. That is because the aforementioned first distribution does not genuinely indicate the distribution unique to the content having the history of being assessed positively, but it is originally influenced by the distribution of all the contents (i.e. the third distribution) to a greater or lesser extent. The same is true for the second distribution as well. As a specific aspect example of the correction, it is considered, but not limited to, that the first and second distributions are divided by the third distribution before making the score curve, or that the made score curve is divided by the third distribution, or the like. In any cases, the correction is performed in this manner and the contribution by the third distribution to the shape of the score curve is reduced, so that the assessment accuracy is further improved.

In another aspect of the content assessing apparatus of the present invention, the interpolating device further interpolates a third distribution of the feature related to the plurality of contents, and the content assessing apparatus is further provided with a correcting device for correcting the interpolated first distribution and the interpolated second distribution, on the basis of the interpolated third distribution so as to reduce a contribution by the third distribution to a shape of the score curve.

According to this aspect, the first and second distributions are corrected on the interpolated third distribution. Thus, as in the case where the score curve is corrected as described above, the contribution by the third distribution to the shape of the score curve is reduced, so that the assessment accuracy is further improved.

(Content Searching Apparatus)

The above object of the present invention can be also achieved by a content searching apparatus provided with: the content assessing apparatus according to claim 1; a searching device for searching for the content suitable for the one search word from the plurality of contents, on the basis of the calculated score; and an outputting device for outputting the searched content to a user.

According to the content searching apparatus of the present invention, the score is calculated for each of the plurality of contents, by the content assessing apparatus according to claim 1. On the basis of the score calculated in this manner, the content suitable for the one search word is searched for, from the plurality of contents, by the searching device having an arithmetic apparatus or the like. Specifically, for example, the score is calculated for the score in the one search word, and several contents with a relatively high score are searched for, as the content suitable for the one search word. The content searched in this manner is outputted to the user by the outputting device having a display or the like. Therefore, if the contents are music pieces, the user can select and play (or reproduce) the desired music piece from the outputted several music pieces. As explained above, according to the content searching apparatus of the present invention, it is possible to preferably search for the content on the basis of the score calculated accurately, and the search accuracy is also improved, which is extremely useful in practice.

In one aspect of the content searching apparatus of the present invention, the searching device searches for the content in which the calculated score exceeds a predetermined score threshold value, from the plurality of contents.

According to this aspect, the content in which the calculated score exceeds the predetermined score threshold value is searched for, from the plurality of contents, by the searching device. The “predetermined score threshold value” is a value calculated by experiments or simulations in advance, as a lower limit value of the score in which the content can be regarded as being suitable for the one search word. The predetermined score threshold value may be fixed, or changed in an ex-post way by the user. Such limitation enables only a necessary amount to be outputted, even in case of a huge amount of contents, which is extremely useful in practice.

In another aspect of the content searching apparatus of the present invention, it is further provided with an updating device for updating a history assessed for the searched content, in accordance with the assessment by the user.

According to this aspect, the history assessed for the searched content is updated by the updating device in accordance with the assessment by the user. For example, if the user feels that the searched content in the search word of “cheerful” is “cheerful”, the user positively assesses it, i.e. the user makes an assessment of “FIT”, and the history is updated in accordance with the assessment. On the other hand, if the user does not feel that it is “cheerful”, the user negatively assesses it, i.e. the user makes an assessment of “UNFIT”, and the history is updated in accordance with the assessment. Typically, it is updated from the oldest history. The “assessment by the user” is typically made in two steps of “FIT” or “UNFIT”, or in more steps. The assessment may be performed by the user manually selecting from options on a display, or automatically performed by analyzing the brain waves or the like of the user who is listening to or watching the content. As described above, if the history is updated, the score curve is made on the basis of as the user's new subjective judgment as possible, to thereby search for the content, and the search accuracy is improved.

(Content Assessing Method)

The above object of the present invention can be also achieved by a content assessing method of assessing suitability for one search word related to one content of a plurality of contents, which are stored on a recoding apparatus, the content assessing method provided with: an extracting process of extracting a feature amount, which quantitatively features the content, for each of the plurality of contents; an interpolating process of interpolating a distribution of the feature amount related to the content having a history of being assessed positively or negatively in the one search word, of the plurality of contents; a making process of making a score curve in which a score is associated with the feature amount, on the basis of the interpolated distribution; and a calculating process of calculating the score, on the basis of the made score curve.

According to the content assessing method of the present invention, as in the content assessing apparatus of the present invention described above, it is possible to preferably assess how suitable the one content is for the one search word.

Incidentally, even the content assessing method of the present invention can adopt the same various benefits as those of the content assessing apparatus of the present invention described above.

(Content Searching Method)

The above object of the present invention can be also achieved by a content searching method provided with: a calculating process of calculating the score for each of the plurality of contents on the basis of the content assessing method according to claim 8; a searching process of searching for the content suitable for the one search word from the plurality of contents, on the basis of the calculated score; and an outputting process of outputting the searched content to a user.

According to the content searching method of the present invention, as in the content searching apparatus of the present invention described above, it is possible to preferably search for the content on the basis of the score accurately calculated, and the search accuracy is also improved. Thus, it is extremely useful in practice.

Incidentally, even the content searching method of the present invention can adopt the same various benefits as those of the content searching apparatus of the present invention described above.

(First Computer Program)

The above object of the present invention can be also achieved by a first computer program making a computer function as the content assessing apparatus according to claim 1.

According to the computer program of the present invention, as in the content assessing apparatus of the present invention described above, it is possible to preferably assess how suitable the one content is for the one search word.

Incidentally, even the computer program of the present invention can adopt the same various benefits as those of the content assessing apparatus of the present invention described above.

The above object of the present invention can be also achieved by a first computer program product in a computer-readable medium for tangibly embodying a program of instructions executable by a computer provided for the content assessing apparatus of the present invention described above (including its various aspects), the computer program product making the computer function as at least one portion of the content assessing apparatus (specifically, e.g. at least one of the extracting device, the interpolating device, the making device, and the calculating device).

According to the first computer program product of the present invention, the aforementioned content assessing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the first computer program product may include computer readable codes to cause the computer (or may comprise computer readable instructions for causing the computer) to function as the aforementioned content assessing apparatus of the present invention.

(Second Computer Program)

The above object of the present invention can be also achieved by a second computer program making a computer function as the content searching apparatus according to claim 5.

According to the computer program of the present invention, as in the content searching apparatus of the present invention described above, it is possible to preferably search for the content

Incidentally, even the computer program of the present invention can adopt the same various benefits as those of the content searching apparatus of the present invention described above.

The above object of the present invention can be also achieved by a second computer program product in a computer-readable medium for tangibly embodying a program of instructions executable by a computer provided for the content searching apparatus of the present invention described above (including its various aspects), the computer program product making the computer function as at least one portion of the content searching apparatus (specifically, e.g. at least one of the searching deice and the outputting device).

According to the second computer program product of the present invention, the aforementioned content searching apparatus of the present invention can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device More specifically, the first computer program product may include computer readable codes to cause the computer (or may comprise computer readable instructions for causing the computer) to function as the aforementioned content searching apparatus of the present invention.

As explained above, according to the content assessing apparatus of the present invention, it is provided with the extracting device, the interpolating device, the making device, and the calculating device, and according to the content assessing method of the present invention, it is provided with the extracting process, the interpolating process, the making process, and the calculating process. Thus, it is possible to preferably assess the for the one search word related to the one content. In addition, according to the computer program of the present invention, it makes a computer function as the extracting device, the interpolating device, the making device, and the calculating device, so that it is possible to construct the content assessing apparatus of the present invention, relatively easily. Moreover, according to the content searching apparatus of the present invention, it is provided with the searching device and the outputting device in addition to the content assessing apparatus described above, and according to the content searching method of the present invention, it is provided with the searching process and the outputting process in addition to the content assessing method described above. Thus, it is possible to preferably search for the content on the basis of the assessment result.

These effects and other advantages of the present invention will become more apparent from an embodiment explained below.

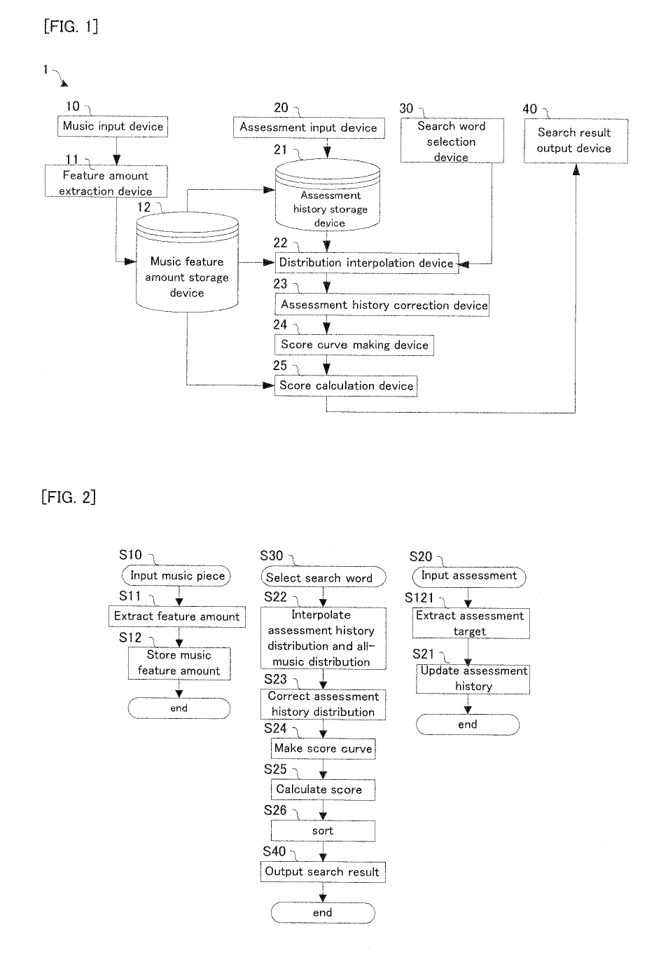

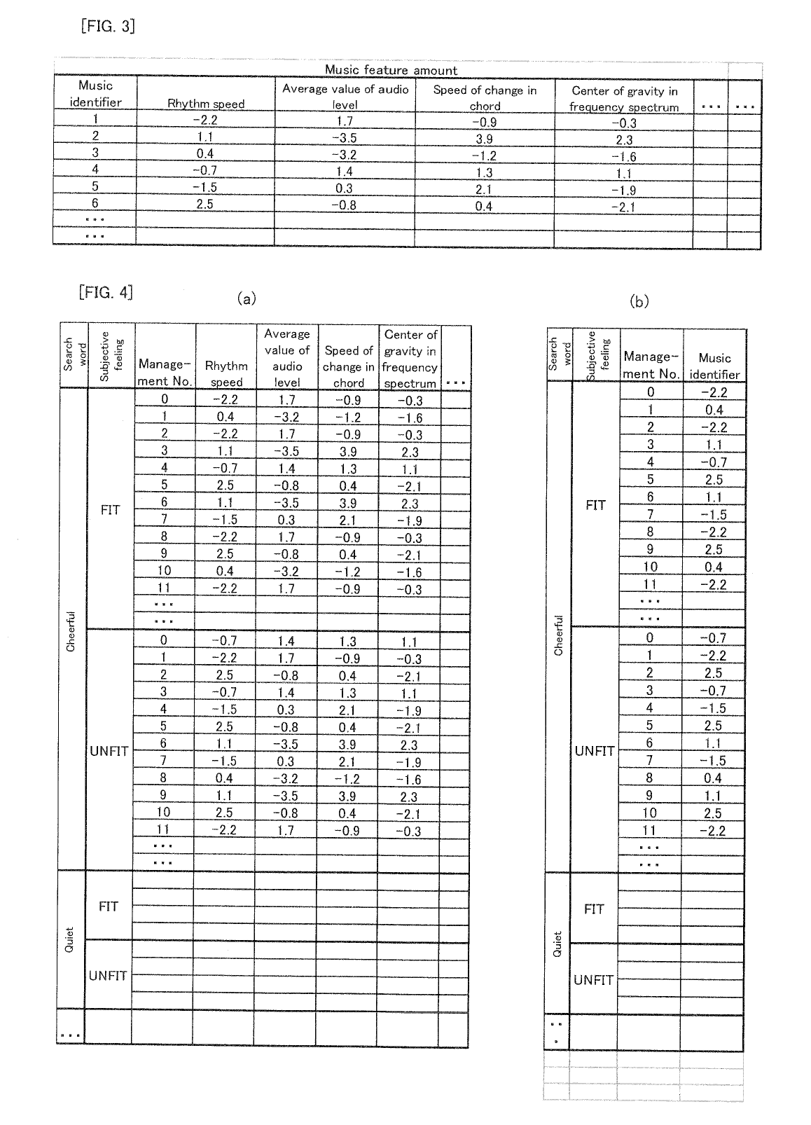

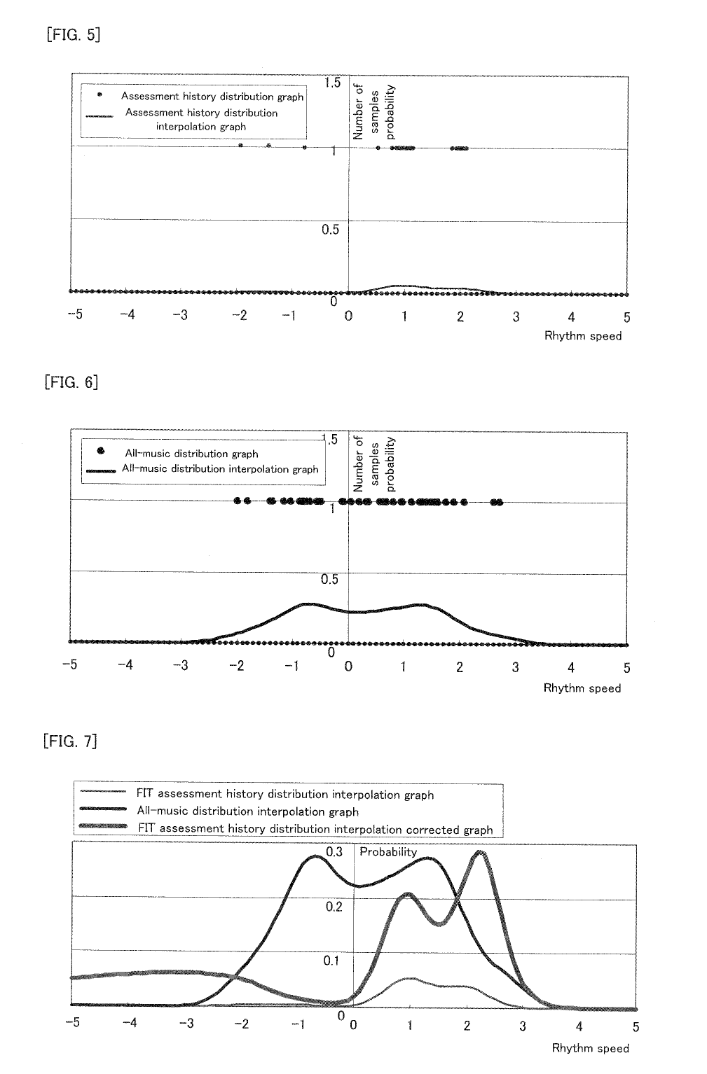

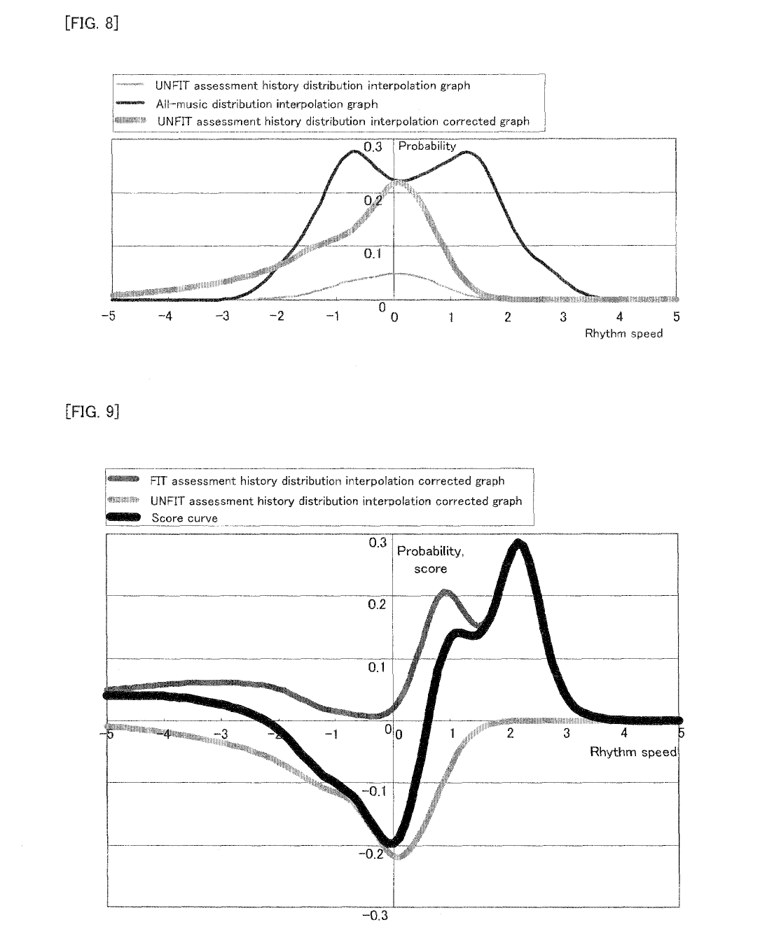

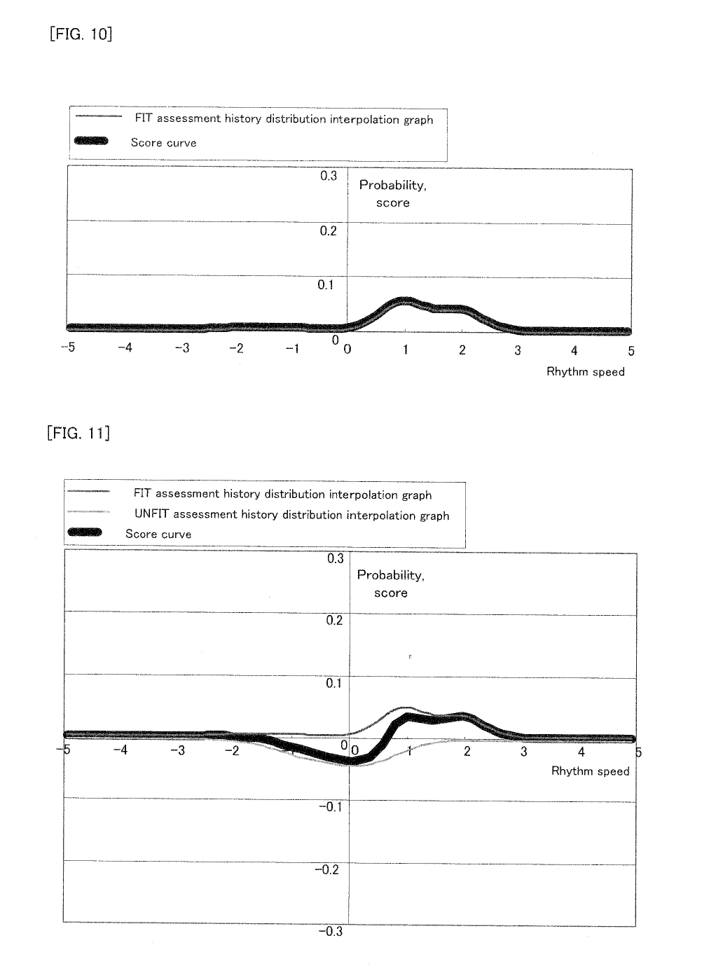

### BRIEF DESCRIPTION OF DRAWINGS

[FIG. 1] FIG. 1 is a block diagram conceptually showing the basic structure of a content searching apparatus equipped with a content assessing apparatus in an embodiment of the present invention.

[FIG. 2] FIG. 2 is a flowchart showing an operation process of the content searching apparatus in the embodiment.

[FIG. 3] FIG. 3 is a list of music feature amounts extracted for each music piece in the embodiment.

[FIG. 4] FIG. 4 are lists of an assessment history in which a search word is subjectively assessed, in the embodiment.

[FIG. 5] FIG. 5 is a characteristic diagram showing an assessment history distribution interpolation graph when the music feature amount is a “rhythm speed” in the embodiment.

[FIG. 6] FIG. 6 is a characteristic diagram showing an all-music distribution interpolation graph when the music feature amount is the “rhythm speed” in the embodiment.

[FIG. 7] FIG. 7 is a characteristic diagram showing a process of making a FIT assessment history distribution interpolation corrected graph when the music feature amount is the “rhythm speed” in the embodiment.

[FIG. 8] FIG. 8 is a characteristic diagram showing a process of making an UNFIT assessment history distribution interpolation corrected graph when the music feature amount is the “rhythm speed” in the embodiment.

[FIG. 9] FIG. 9 is a characteristic diagram showing a process of making a score curve when the music feature amount is the “rhythm speed” in the embodiment.

[FIG. 10] FIG. 10 is a characteristic diagram showing a process of making the score curve when the “score curve=FIT assessment history distribution interpolation” in the embodiment.

[FIG. 11] FIG. 11 is a characteristic diagram showing a process of making the score curve when the “score curve FIT assessment history distribution interpolation graph−UNFIT assessment history distribution interpolation graph” in the embodiment.

### DESCRIPTION OF REFERENCE CODES

1 content searching apparatus
11 feature amount extraction device
22 distribution interpolation device
24 score curve making device
25 score calculation device

### BEST MODE FOR CARRYING OUT THE INVENTION

Hereinafter, the best mode for carrying out the present invention will be explained in order in each embodiment with reference to the drawings. Hereinafter, an embodiment of the present invention will be explained with reference to the drawings.

### (1) Embodiment

With reference to FIG. 1 to FIG. 9, an explanation will be given on the structure and operation of a content searching apparatus equipped with a content assessing apparatus in the embodiment.

### (1-1) Structure

Firstly, with reference to FIG. 1, an explanation will be given on the structure of the content searching apparatus equipped with the content assessing apparatus in the embodiment. FIG. 1 is a block diagram conceptually showing the basic structure of the content searching apparatus equipped with the content assessing apparatus in the embodiment of the present invention.

As shown in FIG. 1, a content searching apparatus 1 in the embodiment is an apparatus for searching for a music piece as one example of the content which is a search target. The content searching apparatus 1 is provided with: a music input device 10; a feature amount extraction device 11; a feature amount storage device 12; an assessment input device 20; an assessment history storage device 21; a distribution interpolation device 22; an assessment history correction device 23; a score curve making device 24; a score calculation device 25; a search word selection device 30; a search result output device 40. Of them, the music input device 10 to the score calculation device 25 also function as the “content assessing apparatus” of the present invention. Hereinafter, the details of each device will be explained.

The music input device 10 is a disc player for performing reproduction on a disc, such as a CD, or a streaming interface for receiving the streaming distribution of music data. The music input device 10 inputs waveform data of the music piece, which is one example of the “content” of the present invention, and an identifier of the music piece. The waveform data of the music piece is inputted as e.g. PCM data or MP3 data through media, such as a CD, or through the Internet.

The feature amount extraction device 11 is one example of the “extracting device” of the present invention, and includes an arithmetic circuit, such as a CPU. The feature amount extraction device 11 quantitatively analyzes and extracts a music feature amount (e.g. a rhythm speed, an average value of audio level, a speed of change in chord, center of gravity in a frequency spectrum, and the like) from the inputted waveform data (refer to FIG. 3).

The feature amount storage device 12 includes a memory apparatus, such as a hard disk. The feature amount storage device 12 associates the extracted music feature amount in each music piece, like a relational database, and stores them in an identifiable way. Moreover, the stored music feature amount is read in updating an assessment history, in interpolating each feature amount distribution, or in calculating a score.

The assessment input device 20 is one example of the “updating device” of the present invention, and includes an input device, such as a touch panel. The assessment input device 20 is adapted to input a value (i.e. “subjective information”) which indicates whether or not an image of a music piece M based on a user's subjective feeling is suitable for a search word S (e.g. “cheerful” or the like) and to update the assessment history. For example, the user can input an assessment of “FIT” if the user positively feels that the listened music piece M is “cheerful”, and an assessment of “UNFIT” if the user negatively feels that it is “not cheerful”, so that the assessment history can be updated. The assessment is not limited to the two step of “FIT” or “UNFIT”, and a more detailed assessment with three or more steps may be inputted. The assessment may adopt a default value before the input by the user. Incidentally, the assessment is not necessarily inputted by hand. For example, the assessment input device 20, which can quantify the feeling by analyzing the spectrum frequency of the user's brain waves and which can output it as a feeling value, may automatically make the assessment on the basis of the feeling when the user listens to the music piece M. In general, a human's brain reacts to a given stimulation, and the brain waves change in accordance with the brain's reaction. It is acknowledged that there is cerebral localization of functions, i.e. a relating region is different depending on the feeling status, such as anger, joy, and sadness. Consequently, a related region and an unrelated region cause a characteristic potential distribution. Therefore, the characteristic potential distribution can be used for the automatic assessment.

The assessment history storage device 21 includes a memory apparatus, such as a hard disk. The assessment history storage device 21 reads the inputted feature amount of the music piece M, and additionally records it in the assessment history for the search word S. In other words, the search word S is associated with the feature amount of the music piece M. If the assessment has two steps such as “FIT” or “UNFIT”, the assessment history is classified in a FIT history and an UNFIT history on the basis of the inputted assessment result, i.e. the assessment history is sorted into either history on the basis of the inputted assessment result.

The distribution interpolation device 22 includes a CPU, a memory, or the like, and interpolates various discrete graphs on the basis of an interpolation technique, such as a mixture Gaussian model. Specifically, the distribution interpolation device 22 reads the assessment history, makes a distribution graph of each of an arbitrary search word, an arbitrary subjective feeling, and an arbitrary feature amount (also referred to an “assessment history distribution graph”, refer to FIG. 5), and makes a graph obtained by interpolating the above graph (also referred to as an “assessment history distribution interpolation graph”, refer to FIG. 5). Moreover, the distribution interpolation device 22 makes a distribution graph of an arbitrary feature amount in all the stored music pieces (also referred to as an “all-music distribution graph”, refer to FIG. 6) and further makes a graph obtained by interpolating the above graph (also referred to as an “all-music distribution interpolation graph”, refer to FIG. 6).

The assessment history correction device 23 is one example of the “correcting device” of the present invention and includes a CPU, a memory, or the like. The assessment history correction device 23 makes an assessment history distribution interpolation corrected graph, which is obtained by correcting the assessment history distribution interpolation graph with the all-music distribution interpolation graph, in each step of the assessment. If the assessment has two steps, such as “FIT” or “UNFIT”, the assessment history correction device 23 makes the graph obtained by correcting each of the FIT and UNFIT assessment history distribution interpolation graphs with the all-music distribution interpolation graph (wherein the corrected graphs are referred to as a “FIT assessment history distribution interpolation corrected graph” and an “UNFIT assessment history distribution interpolation corrected graph”, respectively, refer to FIG. 7 and FIG. 8).

The score curve making device 24 is one example of the “making device” of the present invention and includes a CPU, a memory, or the like. The score curve making device 24 generates a score curve necessary to calculate a score, on the basis of the assessment history distribution interpolation graph or the assessment history distribution interpolation corrected graph (refer to FIG. 9). Incidentally, the score curve may be the FIT assessment history distribution interpolation graph or the FIT assessment history distribution interpolation corrected graph. Alternatively, it may be an inverted graph of inverting the plus or minus of the UNFIT assessment history distribution interpolation graph or the UNFIT assessment history distribution interpolation corrected graph. Alternatively, it may be a graph obtained by subtracting the UNFIT assessment history distribution interpolation graph from the FIT assessment history distribution interpolation graph, or may be a graph obtained by further correcting the above graph with the all-music distribution interpolation graph. Alternatively, it may be a graph obtained by subtracting UNFIT assessment history distribution interpolation corrected graph from the FIT assessment history distribution interpolation corrected graph. In any cases, the score curve is made on the basis of at least the interpolated distribution graph of the feature amount.

The score calculation device 25 is one example of the “calculating device” of the present invention and includes a CPU, a memory, or the like. The score calculation device 25 reads the feature amount of each content and calculates a value associated with the feature amount on the score curve, as a score. That is, the score calculation device 25 assesses the content as the content assessing apparatus. In particular, in the score calculation, the score is associated with an arbitrary feature amount on the score curve, so that the score associated with the feature amount can be read on the score curve even in any value of the feature amount of the content, which is an assessment target. Therefore, even if the distribution graph of the feature amount (first distribution) is not a normal distribution, the score accuracy is higher than the case where the score is calculated as the distance from the average value without the interpolation, which is extremely useful in practice.

The search word selection device 30 is one example of the “searching device” of the present invention and includes an input device, such as a touch panel. The search word selection device 30 is constructed such that the user can select the particular search word S from a plurality of search words displayed on a display.

The search result output device 40 is one example of the “outputting device” and includes a display or the like. The search result output device 40 is adapted to display a music piece which corresponds to (i.e. which FITs) the selected search word S, as a search result, for the user. When the user determines a preferred music piece from the search result, the music piece is played or reproduced.

The content searching apparatus 1 equipped with the content assessing apparatus in the embodiment is constructed as explained above using FIG. 1, so that the content searching apparatus 1 can preferably search for the content, from the contents accumulated on a recording apparatus, on the basis of the score which is calculated accurately by the content assessing apparatus.

### (1-2) Operation Process

Next, an explanation will be given on the operation process of the content searching apparatus 1 in the embodiment, with reference to FIG. 3 to FIG. 9, as occasion demands, and on the basis of FIG. 2 in addition to FIG. 1. FIG. 2 is a flowchart showing the operation process of the content searching apparatus in the embodiment.

(a) Music Piece Input

In FIG. 2, firstly, the music piece which is a search target is inputted as follows, and the feature amount is extracted and stored. Specifically, firstly, the waveform data of the music piece and the identifier of the music piece are inputted through the music input device 10 so that the music piece is set to be the search target in factory shipment in advance, or in an ex-post way by the user (step S10). The waveform data is quantitatively analyzed by the feature amount extraction device 11, and the music feature amount (e.g. a rhythm speed, an average value of audio level, a speed of change in chord, center of gravity in a frequency spectrum, and the like) is extracted (step S11). The extracted feature amount is standardized by an average which is a reference and a standard deviation which is a reference, and is stored into the feature amount storage device 12 in associated with the identifier of the music piece, as shown in FIG. 3 (step S12). FIG. 3 is a list of music feature amounts extracted for each music piece in the embodiment. In FIG. 3, the “rhythm speed” of a music piece with an identifier 1 is “−2.2”, and the average value of the audio level is “1.7”.

(b) Assessment Input

Back in FIG. 2, the assessment for the music piece is performed as follows, in factory shipment in advance, or in an ex-post way by the user who has listened to the music piece searched for on the basis of the search word. Specifically, firstly, as the assessment (FIT or UNFIT) for the music piece M, the subjective information is inputted through the assessment input device 20, wherein the subjective information indicates whether or not the image of the music piece M based on the user's subjective feeling is suitable for the search word S (step S20). Moreover, the feature amount of the music piece M which is the assessment target is read from the feature amount storage device 12 on the basis of the identifier of the music piece M (step S121). The feature amount is stored into the assessment history storage device 21 as the assessment history as shown in FIG. 4(a), with the subjective information of the music piece M about the search word S (step S21). At this time, since a capacity in which the assessment history can be stored is limited, for example, the oldest history is overwritten. Here, FIG. 4 are lists of the assessment history in which the search word is subjectively assessed, in the embodiment. In FIG. 4(a), in the assessment history, the feature amount of the music piece which is assessed (FIT or UNFIT) for each search word is stored with a management number. For example, in the search word of “cheerful”, the feature amount of each music piece which obtains the assessment of “FIT” is stored with the management number, like the management number of 0, 1, 2, . . . 10, 11, and so on. Incidentally, as shown in FIG. 4(b), the assessment history storage device 21 may store the identifier of the music piece with the feature amount, as the assessment history, instead of the feature amount. That is, with the identifier of the music piece as a key, the assessment history shown in FIG. 4(b) and the music feature amount shown in FIG. 3 may be associated as the so-called relational database. In this case, even if the feature amount cannot be directly read from the assessment history storage device 21, the feature amount can be indirectly from the music feature amount storage device 12 following the identifier of the music piece. Therefore, it is possible to save the capacity of the assessment history storage device 21 while maintaining the capability of reading the music feature amount necessary to make the assessment history distribution graph.

(c) Search Word Selection

Back in FIG. 2, for example, if the user wants to listen to the “cheerful” music piece, the music piece can be searched for as follows. Specifically, firstly, the search word of “cheerful” is selected by the user through the search word selection device 30 (step S30). With regard to the music feature amount recorded in the assessment history for the selected search word “cheerful”, the distribution interpolation device 22 interpolates the distribution of the music piece assessed (assessment history distribution graph), with a mixture Gaussian model or the like, and obtains the assessment history distribution interpolation graph shown in FIG. 5 (step S22). FIG. 5 is a characteristic diagram showing the assessment history distribution interpolation graph when the music feature amount is the “rhythm speed” in the embodiment.

In FIG. 5, the horizontal axis indicates the “rhythm speed”, which is one example of the feature amount, and the vertical axis indicates the “number of samples” of music pieces before the interpolation and the “probability” that the samples exist after the interpolation. Such an assessment history distribution interpolation graph is made for what “FITs” the “rhythm speed” and what “UNFITs” the “rhythm speed” (refer to the “FIT assessment history distribution interpolation corrected graph” in FIG. 7 and the “UNFIT assessment history distribution interpolation corrected graph” in FIG. 8). The same assessment history distribution interpolation graph is made for the other feature amounts. As a result of the interpolation, it is possible to preferably perform the score calculation, even on the music piece having the “rhythm speed” that is not stored in the assessment history.

Moreover, the interpolation of the distribution as described above is also performed on the feature amounts of all the music pieces stored in the feature amount storage device 12. For example, as shown in FIG.6, with regard to the “rhythm speed”, the all-music distribution graph, which indicates a distribution of all the music pieces stored in the feature amount storage device 12, is approximated by a mixture Gaussian model or the like to make the all-music distribution interpolation graph. FIG. 6 is a characteristic diagram showing the all-music distribution interpolation graph when the music feature amount is the “rhythm speed” in the embodiment.

Then, the assessment history correction device 23 corrects the assessment history distribution interpolation graph in FIG. 5 to thereby make the assessment history distribution interpolation corrected graph (step S23). Specifically, the FIT assessment history distribution interpolation corrected graph shown in FIG. 7 is made as “FIT assessment history distribution interpolation corrected graph=FIT distribution interpolation graph/all-music distribution interpolation graph”. FIG. 7 is a characteristic diagram showing a process of making the FIT assessment history distribution interpolation corrected graph when the music feature amount is the “rhythm speed” in the embodiment.

In the same manner, the UNFIT assessment history distribution interpolation corrected graph shown in FIG. 8 is made as well. FIG. 8 is a characteristic diagram showing a process of making the UNFIT assessment history distribution interpolation corrected graph when the music feature amount is the “rhythm speed” in the embodiment.

As a result of the collection described above, the accuracy of each of the FIT and UNFIT assessment history distribution interpolation corrected graphs is improved. This is because the distribution of all the music pieces is not necessarily uniform in the first place, and without the correction it is hard to judge whether the distribution shape of the assessment history distribution interpolation graph is unique to the feature amount or it is originally made in such a distribution. Then, the same correction is performed on each feature amount.

Then, the score curve making device 24 makes the score curve for each feature amount, on the basis of the UNFIT assessment history distribution interpolation corrected graph (step S24). Specifically, the score curve as shown in FIG. 9 is made as “score curve=FIT assessment history distribution interpolation corrected graph−UNFIT assessment history distribution interpolation corrected graph”. FIG. 9 is a characteristic diagram showing a process of making the score curve when the music feature amount is the “rhythm speed” in the embodiment. The score curve is made in the same manner for the other feature amounts. As a result, not only the distribution for “FIT” which is a positive assessment but also the distribution for “UNFIT” which is a negative assessment are taken into account, so that it is possible to obtain the score curve that reflects the user's preference, more strongly.

Incidentally, the equation used to make the score curve is not limited to the aforementioned equation. For example, the score curve may be made in accordance with any one of equations “score curve=FIT assessment history distribution interpolation graph”, “score curve=−UNFIT assessment history distribution interpolation graph”, “core curve=FIT assessment history distribution interpolation graph−UNFIT assessment history distribution interpolation graph”, “score curve=FIT assessment history distribution interpolation graph/all-music distribution interpolation graph”, “score curve UNFIT assessment history distribution interpolation graph/all-music distribution interpolation graph”, and “score curve=(FIT assessment history distribution interpolation graph−UNFIT assessment history distribution interpolation graph)/all-music distribution interpolation graph”. In any cases, since the score curve is made on the basis of at least the interpolated distribution, the score accuracy is higher than the case where the score is calculated as the distance from the average value without interpolation. The score curves made in accordance with the first and third equations of the above six equations are shown in FIG. 10 and FIG. 11. FIG. 10 is a characteristic diagram showing a process of making the score curve when the “score curve=FIT assessment history distribution interpolation” in the embodiment. FIG. 11 is a characteristic diagram showing a process of making the score curve when the “score curve=FIT assessment history distribution interpolation graph−UNFIT assessment history distribution interpolation graph” in the embodiment. Moreover, the score curve made in accordance with the sixth equation is the same as that shown in FIG. 9.

The score calculation device 25 calculates the score of each music piece in the search word of “cheerful” (step S25). In order to calculate the score in the search word of “cheerful” for the certain music piece M, the scores for the feature amount of the music piece are read on the score curve about each feature amount, and the sum of the read scores in each feature amount is regarded as the final score in the search word of “cheerful” for the certain music piece M. For example, in the search word of “cheerful” for the music piece M, if the score about the “rhythm speed” is 0.14, the score about the “average value of the audio level” is 0.1, the score about the “speed of the change in chord” is 0.2, and the score about the “center of gravity in the frequency spectrum,” is 0.3, the final score in the search word of “cheerful” for the music piece M is 0.14+0.1+0.2+0.3=0.74. Incidentally, in the summing, not only the simple addition but also the addition after different weighting for each feature amount may be performed. The aforementioned score is calculated in the same manner for the other music pieces, and all the music pieces are sorted in the calculated score (step S26).

Then, the sorted music pieces are outputted with the identifiers by the search result output device 40 (step S40). The outputted music pieces may be all the sorted music pieces, or one portion thereof (e.g. scores with a certain positive threshold value or more). From the list of the music pieces outputted as the “cheerful” music, eventually the user can select and play or reproduce the music piece which the user desires to listen to. The user can input the assessment of the music pieces described above through the assessment input device 20 after listening to it (the step S20). As a result, the assessment history is updated, and it is possible to perform the searching reflected by as the new user's feeling as possible on the basis of the updated assessment history.

As explained above with reference to FIG. 3 to FIG. 9 as occasion demands on the basis of FIG. 2 in addition to FIG. 1, according to the content searching apparatus equipped with the content assessing apparatus in the embodiment, it is possible to preferably assess the various contents including the music pieces, and it is possible to perform the accurate searching on the basis of the assessment result.

Moreover, the operation process described in the embodiment may be achieved by operating the content searching apparatus on the basis of a content searching method provided with a searching process and an outputting process in addition to a content assessing method. Alternatively, it may be achieved by making a computer provided for the content searching apparatus, read first and second computer programs.

Incidentally, the content assessing apparatus is not necessarily used for the searching. It will be understood that the content assessing apparatus can be used by itself or in other applications.

Incidentally, the present invention is not limited to the aforementioned embodiment, but various changes may be made, if desired, without departing from the essence or spirit of the invention which can be read from the claims and the entire specification. A content assessing apparatus, a content searching apparatus, a content assessing method, a content searching method, and first and second computer program, all of which involve such changes, are also intended to be within the technical scope of the present invention.

### INDUSTRIAL APPLICABILITY

The content assessing apparatus, the content searching apparatus, the content assessing method, the content searching method, and the first and second computer program according to the present invention can be applied to a content assessing apparatus for assessing suitability for one search word related to one content of a plurality of contents, which are stored on a recoding apparatus, such as a music server.

1-11. (canceled)

12. A content assessing apparatus for assessing suitability for a user's feeling in one search word related to one content of a plurality of contents, which are stored on a recoding apparatus, said content assessing apparatus comprising:
an extracting device for extracting a feature amount, which quantitatively features the content, for each of the plurality of contents;
an interpolating device for interpolating a distribution of the feature amount related to the content having a history in which the suitability for the user's feeling is assessed positively or negatively in the one search word, of the plurality of contents;
a making device for making a score curve in which a score is associated with the feature amount, on the basis of the interpolated distribution; and
a calculating device for calculating or estimating the score which indicates the suitability for the user's feeling in the one search word related to the content which is the one content and which does not have the history, by reading a value on the made score curve corresponding to the feature amount extracted for the one content.

13. The content assessing apparatus according to claim 12, wherein
said interpolating device interpolates a first distribution of the feature amount related to the content having the history assessed positively of the plurality of contents and interpolates a second distribution of the feature amount related to the content having the history assessed negatively of the plurality of contents, and
said making device makes the score curve by subtracting the interpolated second distribution from the interpolated first distribution.

14. The content assessing apparatus according to claim 12, wherein
said interpolating device further interpolates a third distribution of the feature related to the plurality of contents, and
said content assessing apparatus further comprises a correcting device for correcting the score curve on the basis of the interpolated third distribution so as to reduce a contribution by the third distribution to a shape of the score curve.

15. The content assessing apparatus according to claim 13, wherein
said interpolating device further interpolates a third distribution of the feature related to the plurality of contents, and
said content assessing apparatus further comprises a correcting device for correcting the interpolated first distribution and the interpolated second distribution, on the basis of the interpolated third distribution so as to reduce a contribution by the third distribution to a shape of the score curve.

16. A content searching apparatus comprising:
said content assessing apparatus according to claim 12;
a searching device for searching for the content suitable for the one search word from the plurality of contents, on the basis of the calculated score; and
an outputting device for outputting the searched content to a user.

17. The content searching apparatus according to claim 16, wherein said searching device searches for the content in which the calculated score exceeds a predetermined score threshold value, from the plurality of contents.

18. The content searching apparatus according to claim 16, further comprising an updating device for updating a history assessed for the searched content, in accordance with the assessment by the user.

19. A content assessing method of assessing suitability for a user's feeling in one search word related to one content of a plurality of contents, which are stored on a recoding apparatus, said content assessing method comprising:
an extracting process of extracting a feature amount, which quantitatively features the content, for each of the plurality of contents;
an interpolating process of interpolating a distribution of the feature amount related to the content having a history in which the suitability for the user's feeling is assessed positively or negatively in the one search word, of the plurality of contents;
a making process of making a score curve in which a score is associated with the feature amount, on the basis of the interpolated distribution; and
a calculating process of calculating or estimating the score which indicates the suitability for the user's feeling in the one search word related to the content which is the one content and which does not have the history, by reading a value on the made score curve corresponding to the feature amount extracted for the one content.

20. A content searching method comprising:
a calculating process of calculating the score for each of the plurality of contents on the basis of said content assessing method according to claim 19;
a searching process of searching for the content suitable for the one search word from the plurality of contents, on the basis of the calculated score; and
an outputting process of outputting the searched content to a user.

21. A first computer-readable medium containing a first computer program for making a computer function as said content assessing apparatus according to claim 12.

22. A second computer-readable medium containing a second computer program for making a computer function as said content searching apparatus according to claim 16.
